(19) United States
(12) Patent Application Publication
(10) Pub. No.: US 2011/0267439 A1
(43) Pub. Date: Nov. 3, 2011

(54) DISPLAY SYSTEM FOR DISPLAYING MULTIPLE FULL-SCREEN IMAGES AND RELATED METHOD

(76) Inventors: Chien-Chou Chen, Taipei County (TW); Wen-Kang Wei, Taipei County (TW)

(21) Appl. No.: 12/770,770

(22) Filed: Apr. 30, 2010

(51) Int. Cl. H04N 13/04; H04N 5/445

(52) U.S. Cl. 348/53; 348/564; 348/58; 348/E13.075; 348/E05.099

(57) ABSTRACT

A display system displays multiple full-screen images and includes a first video source for outputting a first video signal, a second video source for outputting a second video signal, a display module for displaying an image frame, a system control module for receiving the first video signal and the second video signal, and generating an image signal comprising alternating full-screen image frames of the first and second video signals.

### BACKGROUND OF THE INVENTION

1. Field of the Invention

The present invention relates to display systems, and particularly to a display system for displaying multiple full-screen images and related method.

2. Description of the Prior Art

Television sets allow viewers to watch live broadcast or recorded video provided by television channels or external video sources, such as Digital Versatile Disc (DVD) players, Blu-ray Disc (BD) players, and camcorders. Television sets now have increased display area, decreased depth, and lighter weight as a result of display technologies, such as liquid crystal display (LCD), plasma display, and organic light emitting diode (OLED) display technologies. Television sets also have increased display resolution as a result of the mentioned technologies.

Most television sets are viewed in a home environment. Quite often a family will watch television together on the television set. However, as different family members may have different viewing preferences, conflict may arise over what to watch. As a solution to this problem, many television manufacturers include a function called “Picture in Picture” (PiP) in the television set. Picture in picture technology allows multiple programs to be displayed simultaneously on the television set. Picture in picture not only provides a solution to the problem of multiple viewers desiring to watch multiple, different programs, but also allows viewers to preview multiple programs at once, without having to flip back and forth between two different channels. For example, if two shows that a viewer desires to watch are scheduled at the same time, the viewer may put both shows on the television set at once. If one show is in a commercial break, the viewer may switch audio output to the other show, or vice versa.

Please refer to FIG. 1, which is a diagram illustrating PiP in a television set 10. The television set 10 has a display region 100, which is configured for displaying images. Normally, the display region 100 is utilized for displaying full-screen video. However, when the PiP function is activated, the display region 100 is split into a first display area 110 and a second display area 120. The first display area 110 is utilized for displaying a first video Video A, and the second display area 120 is utilized for displaying a second video Video B. The first video Video A and the second video Video B are inputted to the television set 10 by different video sources, such as a television antenna, a DVD player, a BD player, a personal computer, or a camcorder.

Please refer to FIG. 2, which is a diagram illustrating a second type of PiP utilized in the television set 10. When a PiP function of the second type is activated, the first video Video A is displayed full-screen in the display region 100, and the second video Video B is overlaid in an overlay display area 220. In this configuration, pixels in the overlay display area 220 that originally displayed the first video Video A instead display the second video Video B.

Typically, in both configurations (FIG. 1 and FIG. 2), a first audio track corresponding to the first video Video A is outputted through speakers of the television set 10, and a second audio track corresponding to the second video Video B is either muted or outputted to headphones.

Both of the above configurations exhibit deficiencies in providing all viewers with an enjoyable viewing experience. In the configuration shown in FIG. 1, both videos are shrunk to fit into the screen, effectively halving the screen size for each viewer. In the configuration shown in FIG. 2, the second video Video B is shrunk to less than one quarter of the screen size, which makes the second video Video B nearly unviewable for interested viewers. Further, an entire corner of the first video Video A is overlaid with the second video Video B. Thus, viewers of the first video Video A may miss key moments in the first video Video A, not to mention missing any subtitles that may be overlaid with the second video Video B. Finally, all viewers of the television set 10, whether viewing the first video Video A or the second video Video B, will be distracted by the other video being shown in the display region 100.

### SUMMARY OF THE INVENTION

According to a first embodiment, a display system for displaying multiple video signals in a single display comprises a first video source for outputting a first video signal, a second video source for outputting a second video signal, a liquid crystal display (LCD) module for displaying an image frame, and a system control module coupled to the first video source and the second video source for receiving the first video signal and the second video signal, and generating an image signal comprising alternating full-screen image frames of the first video signal and the second video signal.

According to a second embodiment, a display system for displaying multiple video signals in a single display comprises a first video source for outputting a first video signal, a second video source for outputting a second video signal, a liquid crystal display (LCD) module for displaying an image frame, a system control module coupled to the first video source and the second video source for receiving the first video signal and the second video signal, and generating an image signal comprising a first set of a plurality of pixels of the first video signal and a second set of the plurality of pixels of the second video signal, and a polarizing module attached to the LCD module. The polarizing module comprises a plurality of first polarizing regions of a first polarization and a plurality of second polarizing regions of a second polarization opposite the first polarization. The first set of the plurality of pixels corresponds to the plurality of first polarizing regions, and the second set of the plurality of pixels corresponds to the plurality of second polarizing regions.

According to one embodiment, a method of displaying multiple video signals in a single display comprises receiving a first video signal, receiving a second video signal, generating an image signal comprising alternating full-screen image frames of the first video signal and the second video signal, displaying the image signal in the display, controlling left and right shutters of a first pair of shutter glasses to allow transmission of light in sync with the full-screen image frames of the first video signal, and to block transmission of light in sync with the full-screen image frames of the second video signal, and controlling left and right shutters of a second pair of shutter glasses to allow transmission of light in sync with the full-screen image frames of the second video signal, and to block transmission of light in sync with the full-screen image frames of the first video signal.

According to one embodiment, a method of displaying video signals in a single display comprises providing a first pair of polarized glasses of a first polarization, providing a second pair of polarized glasses of a second polarization opposite to the first polarization, providing a polarizing module attached to a display module of the display, the polarizing module comprising a plurality of first polarizing regions of the first polarization and a plurality of second polarizing regions of the second polarization, receiving a first video signal, receiving a second video signal, generating an image signal comprising a first set of a plurality of pixels of the first video signal and a second set of the plurality of pixels of the second video signal, and displaying the image signal in the display. The first set of the plurality of pixels corresponds to the plurality of first polarizing regions, and second set of the plurality of pixels corresponds to the plurality of second polarizing regions.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating PiP in a television set.

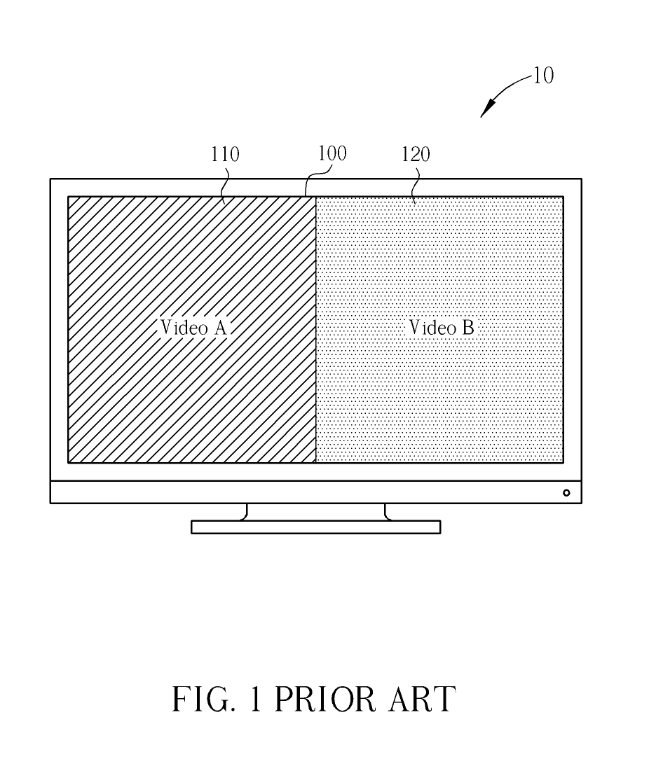

FIG. 2 is a diagram illustrating a second type of PiP utilized in the television set of FIG. 1.

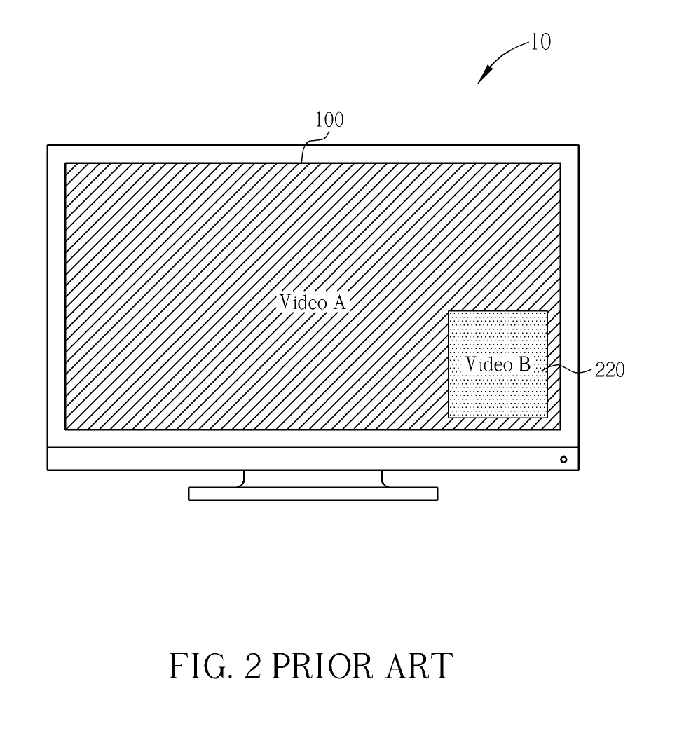

FIG. 3 is a timing diagram illustrating an embodiment of displaying multiple full-screen images in a display.

FIG. 4 is a timing diagram illustrating a second embodiment of displaying multiple full-screen images in a display.

FIG. 5 is a timing diagram illustrating a third embodiment of displaying multiple full-screen images in a display.

FIG. 6 is a diagram illustrating one configuration for displaying multiple full-screen images in a display.

FIG. 7 is a diagram of a polarizing module having a second configuration.

FIG. 8 is a diagram of a polarizing module having a third configuration.

FIG. 9 is a diagram of a display system for displaying multiple full-screen images in a display.

FIG. 10 is a diagram of another display system for displaying multiple full-screen images in a display.

### DETAILED DESCRIPTION

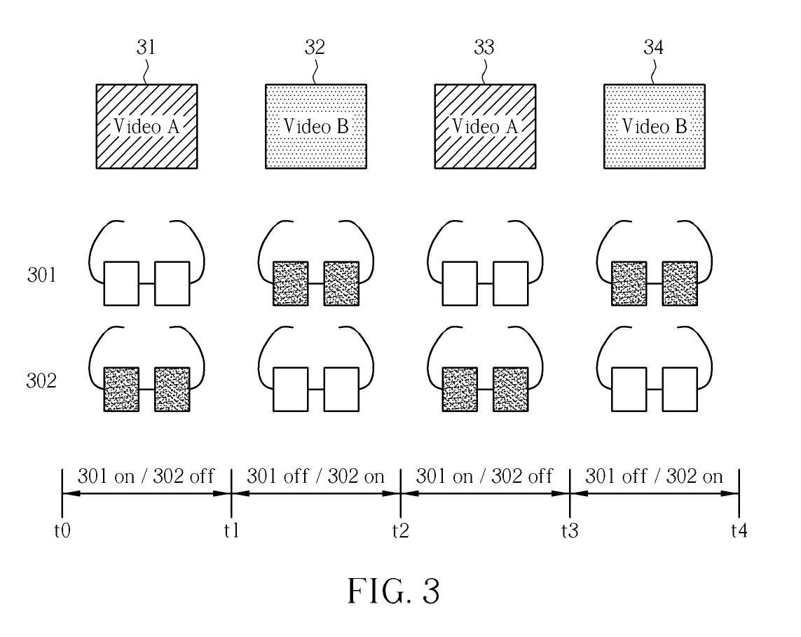

Please refer to FIG. 3, which is a timing diagram illustrating an embodiment of displaying multiple full-screen images in a display. A first video Video A and a second video Video B may be displayed in the display as shown. From a time t0 to a time t1, the first video Video A may be displayed in the display at full resolution of the display. Then, from the time t1 to a time t2, the second video Video B may be displayed in the display at full resolution of the display. From the time t2 to a time t3, the first video Video A may be displayed, and from the time t3 to a time t4, the second video Video B may be displayed.

Two pair of shutter glasses 301, 302 may be synchronized with the display as follows. Shutter glasses may have left and right liquid crystal filters that may be controlled to transmit light or to block light. Traditional shutter glasses utilized for viewing three-dimensional (3D) video only allow one of the two liquid crystal filters to transmit light at a time, alternating between the left filter and the right filter so as to transmit a right eye image to a viewer's right eye, and a left eye image to the viewer's left eye during alternating time periods. However, in the method shown in FIG. 3, the right and left liquid crystal filters of the first pair of shutter glasses 301 are controlled to transmit light at the same time, and are controlled to block light at the same time, and likewise for the second pair of shutter glasses 302. In a first period from the time t0 to the time t1, the first pair of shutter glasses 301 may allow transmission of light, and the second pair of shutter glasses 302 may block transmission of light. In a second period from the time t1 to the time t2, the first pair of shutter glasses 301 may block transmission of light, and the second pair of shutter glasses 302 may block transmission of light. In a third period from the time t2 to the time t3, the first pair of shutter glasses 301 may allow transmission of light, and the second pair of shutter glasses 302 may block transmission of light. In a fourth period from the time t3 to the time t4, the first pair of shutter glasses 301 may block transmission of light, and the second pair of shutter glasses 302 may block transmission of light. In this way, in the first period, a first viewer wearing the first pair of shutter glasses 301 may view a first frame 31 of the first video Video A, and the first frame 31 may be blocked from view of a second viewer wearing the second pair of shutter glasses 302. In the second period, a second frame 32 of the second video Video B may be blocked from view of the first viewer by the first pair of shutter glasses 301, and may be viewed by the second viewer through the second pair of shutter glasses 302. In the third period, a third frame 33 corresponding to the first video Video A may be viewed by the first viewer through the first pair of shutter glasses 301, and may be blocked from view of the second viewer by the second pair of shutter glasses 302. In the fourth period, a fourth frame 34 corresponding to the second video Video B may be blocked from view of the first viewer by the first pair of shutter glasses 301, and may be viewed by the second viewer through the second pair of shutter glasses 302. Thus, the first viewer may view the first video Video A through the first pair of shutter glasses 301, and the second viewer may view the second video Video B through the second pair of shutter glasses 302. Each viewer may view the corresponding video at half the maximum refresh rate of the display. The above process may be repeated for as many frames as are comprised in the first video Video A and/or the second video Video B.

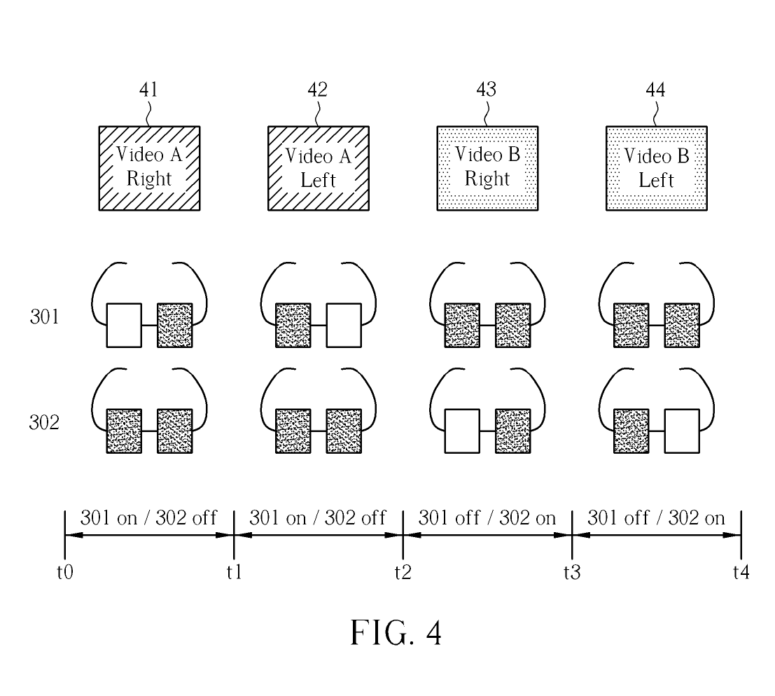

Please refer to FIG. 4, which is a timing diagram illustrating a second embodiment of displaying multiple full-screen images in a display. The first video Video A and/or the second video Video B may also be a 3D video using right and left eye frames to give the viewer an illusion of 3D. In this case, timing of the first pair of shutter glasses 301 and the second pair of shutter glasses 302, as well as timing of the first video Video A and the second video Video B may be accomplished as shown in FIG. 4. In a first period from time t0 to time t1, aright frame 41 of the first video Video A may be displayed in the display at full resolution of the display. In a second period from the time t1 to time t2, a left frame 42 of the first video Video A may be displayed in the display at full resolution of the display. Then, in a third period from the time t2 to time t3, a right frame 43 of the second video Video B may be displayed in the display at full resolution of the display. In a fourth period from the time t3 to time t4, a left frame 44 of the second video Video B may be displayed in the display at full resolution of the display.

The two pair of shutter glasses 301, 302 may be synchronized with the display as follows. Because 3D video is being viewed, only one liquid crystal filter of the four total liquid crystal filters of the first and second pair of shutter glasses 301, 302 may transmit light at a time, alternating between the left filter and the right filter and between the first pair of shutter glasses 301 and the second pair of shutter glasses 302, so as to transmit the right eye image to the viewer's right eye, and the left eye image to the viewer's left eye during alternating time periods. In the method shown in FIG. 4, in the first period, the right filter of the first pair of shutter glasses 301 may allow transmission of light, and the left filter of the first pair of shutter glasses 301 and both filters of the second pair of shutter glasses 302 may block transmission of light. In the second period, the left filter of the first pair of shutter glasses 301 may allow transmission of light, and the right filter of the first pair of shutter glasses 302 and both filters of the second pair of shutter glasses 302 may block transmission of light. In the third period, both filters of the first pair of shutter glasses 301 and the left filter of the second pair of shutter glasses 302 may block transmission of light, and the right filter of the second pair of shutter glasses 302 may allow transmission of light. In the fourth period, both filters of the first pair of shutter glasses 301 and the right filter of the second pair of shutter glasses 302 may block transmission of light, and the left filter of the second pair of shutter glasses 302 may allow transmission of light. In this way, in the first period, a first viewer wearing the first pair of shutter glasses 301 may view a right frame 41 of the first video Video A, and the right frame 41 may be blocked from view of a second viewer wearing the second pair of shutter glasses 302. In the second period, the first viewer may view a left frame 42 of the first video Video A, and the left frame 42 may be blocked from view of the second viewer. In the third period, a right frame 43 of the second video Video B may be viewed by the second viewer, and may be blocked from view of the first viewer. In the fourth period, a left frame 44 of the second video Video B may be viewed by the second viewer, and may be blocked from view of the first viewer. Thus, the first viewer may view the first video Video A through the first pair of shutter glasses 301, and the second viewer may view the second video Video B through the second pair of shutter glasses 302, both in 3D. Each viewer may view the corresponding video at one quarter the maximum refresh rate of the display. Please note that the method shown in FIG. 4 is described for two 3D video sources. However, if only one of the video sources is a 3D video source, both filters of the pair of shutter glasses synchronized with the non-3D video source may allow transmission during periods in which the non-3D video source is displayed in the display. The above process may be repeated for as many frames as are comprised in the first video Video A and/or the second video Video B.

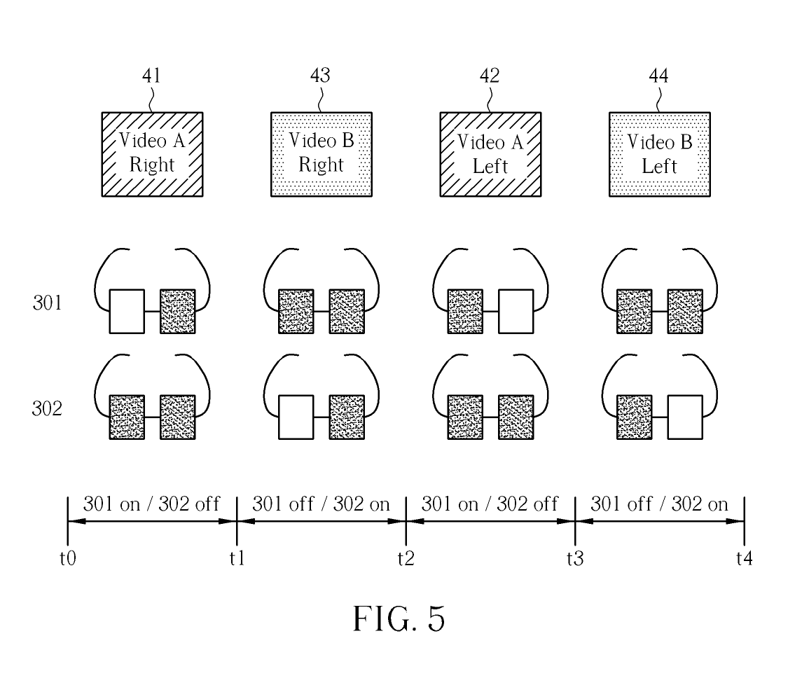

Please refer to FIG. 5, which is a timing diagram illustrating a third embodiment of displaying multiple full-screen images in a display. The embodiment shown in FIG. 5 is similar to the embodiment shown in FIG. 4. In the method shown in FIG. 5, the right frame 41 of the first video Video A may be shown in the first period, the right frame 43 of the second video Video B may be shown in the second period, the left frame of the first video Video A may be shown in the third period, and the left frame of the second video Video B may be shown in the fourth period.

In the first period, the right filter of the first pair of shutter glasses 301 may allow transmission of light, and the left filter of the first pair of shutter glasses 301 and both filters of the second pair of shutter glasses 302 may block transmission of light. In the second period, both filters of the first pair of shutter glasses 301 and the left filter of the second pair of shutter glasses 302 may block transmission of light, and the right filter of the second pair of shutter glasses 302 may allow transmission of light. In the third period, the left filter of the first pair of shutter glasses 301 may allow transmission of light, and the right filter of the first pair of shutter glasses 302 and both filters of the second pair of shutter glasses 302 may block transmission of light. In the fourth period, both filters of the first pair of shutter glasses 301 and the right filter of the second pair of shutter glasses 302 may block transmission of light, and the left filter of the second pair of shutter glasses 302 may allow transmission of light. In this way, in the first period, the first viewer wearing the first pair of shutter glasses 301 may view a right frame 41 of the first video Video A, and the right frame 41 may be blocked from view of the second viewer wearing the second pair of shutter glasses 302. In the second period, the right frame 43 of the second video Video B may be viewed by the second viewer, and may be blocked from view of the first viewer. In the third period, the first viewer may view the left frame 42 of the first video Video A, and the left frame 42 may be blocked from view of the second viewer. In the fourth period, a left frame 44 of the second video Video B may be viewed by the second viewer, and may be blocked from view of the first viewer. Thus, the first viewer may view the first video Video A through the first pair of shutter glasses 301, and the second viewer may view the second video Video B through the second pair of shutter glasses 302, both in 3D. Each viewer may view the corresponding video at one quarter the maximum refresh rate of the display. Please note that the method shown in FIG. 4 and FIG. 5 is described for two 3D video sources. However, if only one of the video sources is a 3D video source, both filters of the pair of shutter glasses synchronized with the non-3D video source may allow transmission during periods in which the non-3D video source is displayed in the display. The above process may be repeated for as many frames as are comprised in the first video Video A and/or the second video Video B.

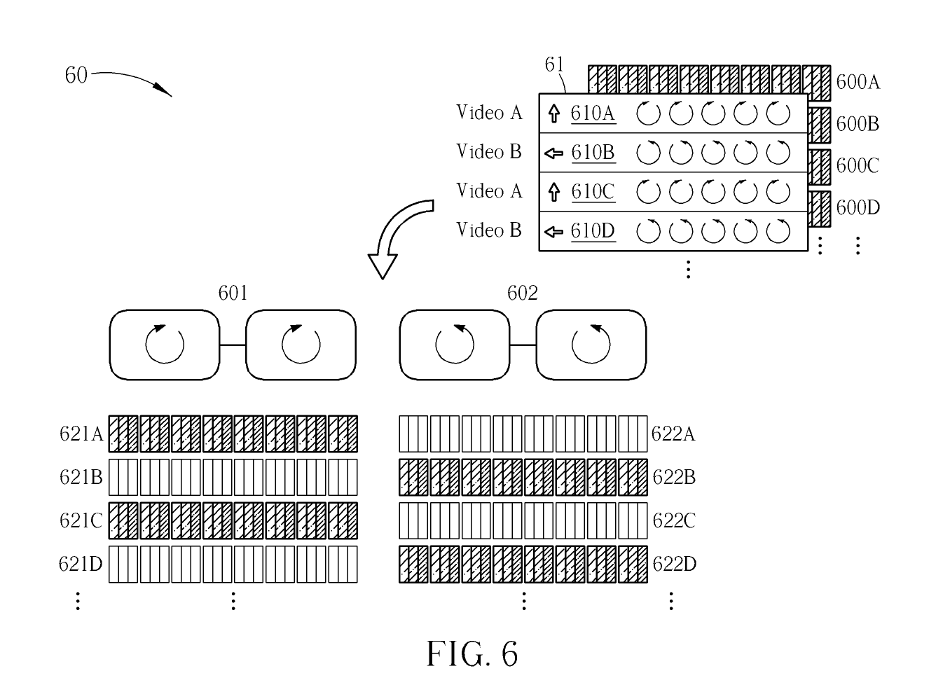

Please refer to FIG. 6, which is a diagram illustrating a display system 60 for displaying multiple full-screen images in a display. In the system 60, a first pair of polarized glasses 601 and a second pair of polarized glasses 602 may be utilized to allow a first viewer to view a first video Video A, and to allow a second viewer to view a second video Video B. A polarizing module 61 having an alternating row pattern comprises a plurality of polarizing rows 610A, 610B, 610C, 610D, and is aligned with display rows 600A, 600B, 600C, 600D, respectively, so as to alternately polarize light emitted from even rows with a first polarization, and light emitted from odd rows with a second polarization opposite the first polarization. Each polarizing row 610A, 610B, 610C, 610D . . . may be one pixel tall, and have length greater than or equal to width of the display, e.g. 1920 pixels. The first display row 600A and the third display row 600C may be given the first polarization by the first polarizing row 610A and the third polarizing row 610C, respectively. The second display row 600B and the third display row 600D may be given the second polarization by the second polarizing row 610B and the fourth polarizing row 610D, respectively. Rows of the first video Video A may be displayed in the first display row 600A and the third display row 600C. Rows of the second video Video B may be displayed in the second display row 600B and the fourth display row 600D. The first video Video A and the second video Video B may be interlaced on the display. The first viewer wearing the first pair of polarized glasses 601 having the first polarization may view the first video Video A. The second viewer wearing the second pair of polarized glasses 602 having the second polarization may view the second video Video B. As shown in FIG. 6, a first received row 621A and a third received row 621C viewed by the first viewer through the first pair of polarized glasses 601 may comprise light of the first display row 600A and the third display row 600C, respectively, allowed to pass through the first pair of polarized glasses 601. A second received row 621B and a fourth received row 621D may be dark, as light of the second display row 600B is blocked and light of the fourth display row 600D is blocked by the first pair of polarized glasses 601. A first received row 622A and a third received row 622C viewed by the second viewer through the second pair of polarized glasses 602 may be dark, as light of the first display row 600A is blocked and light of the third display row 600C is blocked by the second pair of polarized glasses 602. A second received row 622B and a fourth received row 622D may comprise light of the second display row 600B and the fourth display row 600D, respectively, allowed to pass through the second pair of polarized glasses 602.

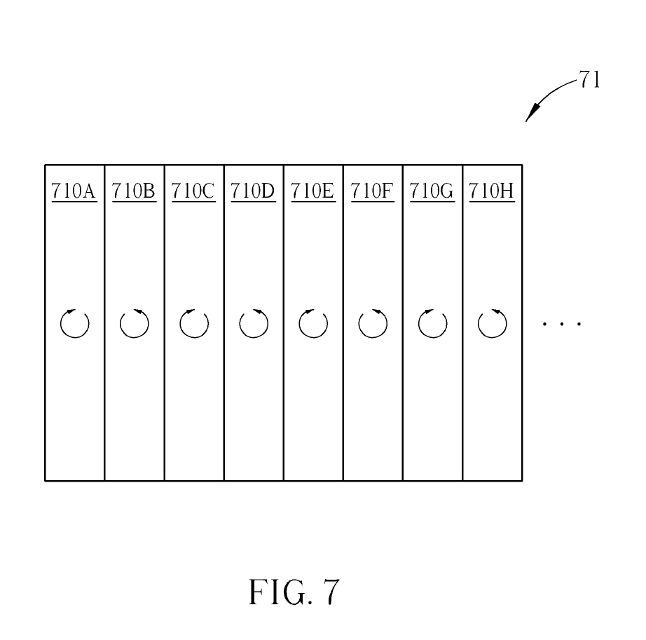

Please note that the alternating row pattern of the polarizing module 61 shown in FIG. 6 is only one possible pattern. Please refer to FIG. 7, which is a diagram of a polarizing module 71 having an alternating column pattern. The polarizing module 71 comprises a plurality of polarizing columns 710A-710H having alternating polarization. Odd polarizing columns 710A, 710C, 710E, 710G of the polarizing module 71 may have the first polarization, and even polarizing columns 710B, 710D, 710F, 710H, may have the second polarization. Each polarizing column 710A-710H may be one pixel wide, and have length greater than or equal to height of the display, e.g. 1080 pixels. Columns of the first video Video A may be displayed in display columns aligned with the odd polarizing columns 710A, 710C, 710E, 710G, and columns of the second video Video B may be displayed in display columns aligned with the even polarizing columns 710B, 710D, 710F, 710H. The first video Video A and the second video Video B may be interlaced on the display. The first pair of polarized glasses 601 may allow light from the odd polarizing columns 710A, 710C, 710E, 710G, and the second pair of polarized glasses 602 may allow light from the even polarizing columns 710B, 710D, 710F, 710H. The first pair of polarized glasses 601 may block light from the even polarizing columns 710B, 710D, 710F, 710H, and the second pair of polarized glasses 602 may block light from the odd polarizing columns 710A, 710C, 710E, 710G.

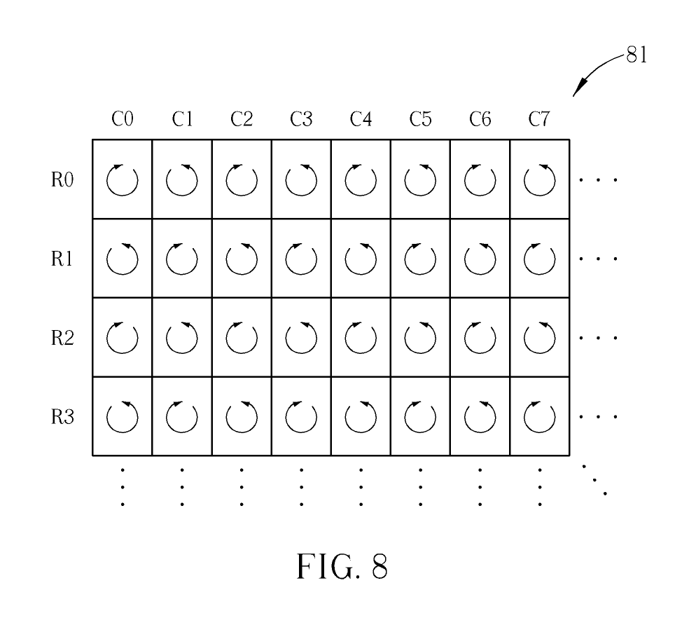

Please refer to FIG. 8, which is a diagram of a polarizing module 81 having a checkerboard pattern. In the polarizing module 81, polarizing blocks may be arranged in rows and columns aligned with pixels of the display. Each row may be one pixel high, and each column may be one pixel wide. The polarizing blocks of the polarizing module 81 may be arranged in a checkerboard formation. For each polarizing block located in an odd row and an odd column, or in an even row and an even column, the polarizing block may have the first polarization. For each polarizing block located in an odd row and an even column, or in an even row and an odd column, the polarizing block may have the second polarization. Each polarizing block will have different polarization from any polarizing block an odd number of blocks away from the polarizing block to the top, bottom, left, or right. Each polarizing block will have the same polarization as any polarizing block an even number of blocks away from the polarizing block to the top, bottom, left, or right.

Please note that, number of polarizing rows of the polarizing module 61, number of polarizing columns of the polarizing module 71, and number of polarizing blocks of the polarizing module 81 are not limited to the numbers shown in FIG. 6, FIG. 7, and FIG. 8, respectively, but should be defined according to size of the display. Each of the above polarizing modules 61, 71, 81 may be made of a polarizing layer that may be applied to the display.

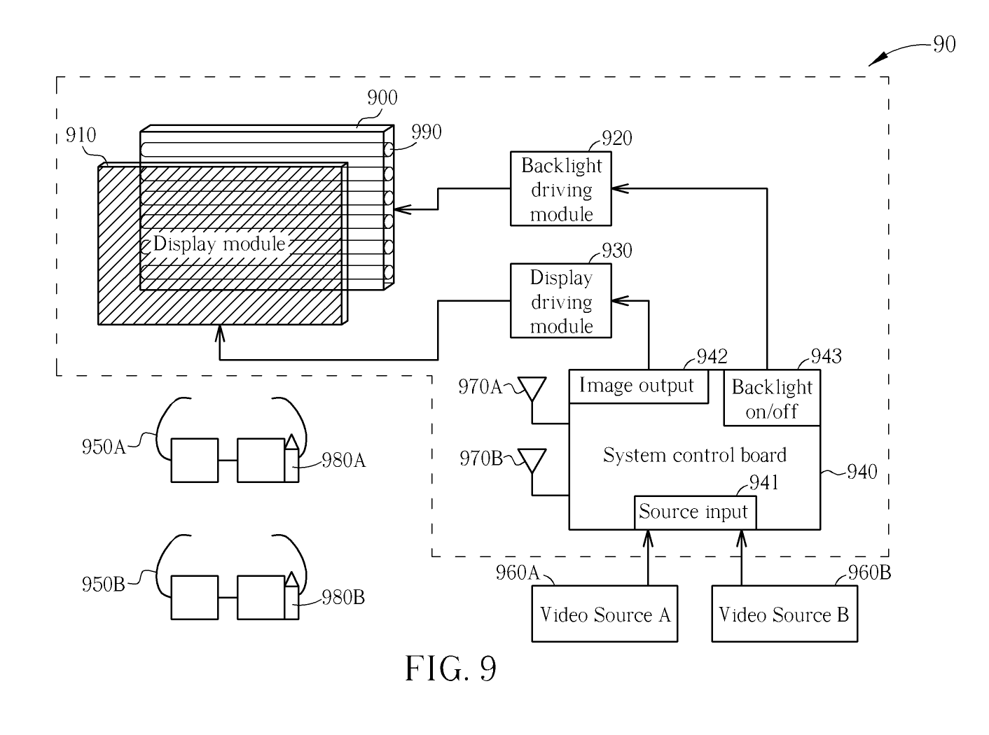

Please refer to FIG. 9, which is a diagram of a display system 90 for displaying full-screen picture-in-picture in a display. The display system 90 comprises a first pair of shutter glasses 950A, a second pair of shutter glasses 950B, a backlight module 900 and a display module 910 for displaying a first video and a second video. The backlight module 900 may comprise a plurality of backlight elements 990, such as cold-cathode fluorescent (CCFL) tubes, light emitting diodes (LEDs), or other such light-emitting elements. The backlight module 900 may be driven by a backlight driving module 920. A display driving module 930 may drive the display module 910 to transmit light or block light from the backlight module 900 to output frames of the first video and the second video. A system control module 940 may comprise a source input module 941, an image output module 942, and a backlight control module 943. The source input module 941 may comprise at least one source input connector for receiving at least one corresponding video source. As shown in FIG. 9, the source input module 941 may receive video and audio signals from a first video source 960A (Video Source A) and a second video source 960B (Video Source B). The image output module 942 may output image data in an image signal to the display driving module 930. The display driving module 930 may drive the display module 910 according to the output image data. The image signal may comprise alternating image frames of the first video and the second video. The system control module 940 may also adjust the video signals received from the first and second video sources 960A, 960B for color, luminance, resolution and/or contrast. The system control module 940 may also control a first transmitter 970A and a second transmitter 970B. The first transmitter 970A may establish a data connection with a first receiver 980A of the first pair of shutter glasses 950A to send a first synchronization signal to the first receiver 980A for synchronizing shuttering of the first pair of shutter glasses 950A with display of the first video, timing of which is described above in FIG. 3, FIG. 4, or FIG. 5. The second transmitter 970B may establish a data connection with a second receiver 980B of the second pair of shutter glasses 950B to send a second synchronization signal to the second receiver 980B for synchronizing shuttering of the second pair of shutter glasses 950B with display of the second video, timing of which is described above in FIG. 3, FIG. 4, or FIG. 5. The data connections established may be wireless or wired.

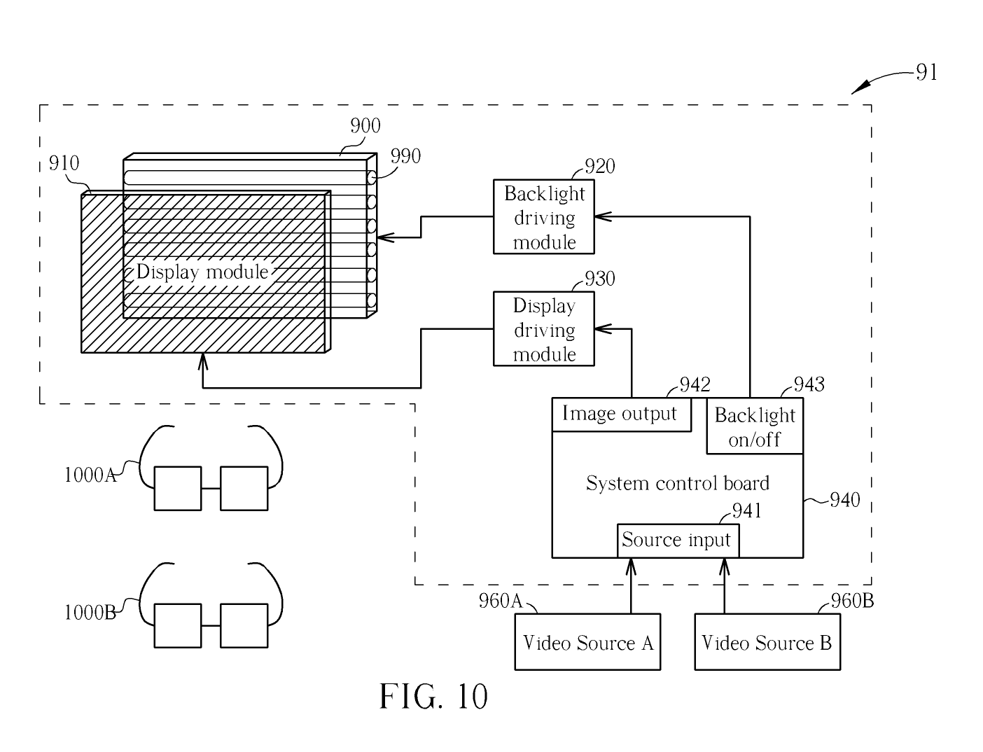

Please refer to FIG. 10, which is a diagram of a display system 91 for displaying full-screen picture-in-picture in a display. Like reference numerals and letters indicate corresponding structure throughout FIG. 9 and FIG. 10. The display system 91 may comprise a first pair of polarized glasses 1000A and a second pair of polarized glasses 1000B. The system control module 940 may arrange pixels of the first and second video according to the configurations shown in FIG. 6, FIG. 7, or FIG. 8 in each video frame sent to the display driving module 930, and the display driving module 930 may control the display module 910 to display the frame. The display system 91 may comprise a corresponding polarizing module 61, 71, 81 (described above) attached to the display module 910.

In the above, the display module 910 may be a liquid crystal display (LCD) module, or a plasma display module. The first video source and the second video source may be output from a digital video disc (DVD) player, Blu-ray Disc (BD) player, video game console, digital television receiver, set-top box, etc. More specifically, the first video source and the second video source may be output from a single video game console and may represent the views of a first player and a second player. In this case, two users or game players may share one display device and watch the entire screen for playing the game instead of watching picture-in-picture images or being influenced by the image of the other player. Audio signals of the first video and the second video may be transmitted wirelessly to wireless headphones. Audio signals corresponding to either the first video or the second video may also be played through speakers.

The display methods shown in FIG. 3 to FIG. 8, and the display systems shown in FIG. 9 and FIG. 10 provide display of multiple video images in a single display at full-screen through the use of shutter glasses or polarized glasses. By alternating frames of multiple video sources, and synchronizing each pair of shutter glasses to a different video source, each viewer may view a different program at full resolution on the display. Thus, each user can enjoy watching his/her program of choice at full resolution, without being distracted by other programs being displayed on the display.

Those skilled in the art will readily observe that numerous modifications and alterations of the device and method may be made while retaining the teachings of the invention.

What is claimed is:

1. A display system for displaying multiple video signals in a single display, the display system comprising:
a first video source for outputting a first video signal;
a second video source for outputting a second video signal;
a display module for displaying an image frame; and
a system control module coupled to the first video source and the second video source for receiving the first video signal and the second video signal, and generating an image signal comprising alternating full-screen image frames of the first video signal and the second video signal.

2. The display system of claim 1, further comprising a backlight module for generating backlight, and a backlight driving module coupled to the backlight module for controlling turning-on and turning-off of the backlight module.

3. The display system of claim 1, further comprising:
a first pair of shutter glasses comprising right and left shutters both turned on in sync with display of the full-screen image frames of the first video signal, and both turned off in sync with display of the full-screen image frames of the second video signal; and
a second pair of shutter glasses comprising right and left shutters both turned on in sync with display of the full-screen image frames of the second video signal, and both turned off in sync with display of the full-screen image frames of the first video signal.

4. The display system of claim 1, wherein the system control board comprises a transmitter, the first pair of shutter glasses further comprises a first receiver for receiving a first synchronization signal from the transmitter for synchronizing the first pair of shutter glasses with the first video signal, and the second pair of shutter glasses further comprises a second receiver for receiving a second synchronization signal from the transmitter for synchronizing the second pair of shutter glasses with the second video signal.

5. The display system of claim 1, wherein the first video signal is a first 3D video signal, and the second video signal is a second 3D video signal.

6. The display system of claim 5, further comprising:
a first pair of shutter glasses comprising right and left shutters; and
a second pair of shutter glasses comprising right and left shutters;
wherein the right shutter of the first pair of shutter glasses is turned on in sync with display of right eye full-screen image frames of the first 3D video signal, and turned off in sync with display of left eye full-screen image frames of the first 3D video signal and right and left eye full-screen image frames of the second 3D video signal;
wherein the left shutter of the first pair of shutter glasses is turned on in sync with display of left eye full-screen image frames of the first 3D video signal, and turned off in sync with display of right eye full-screen image frames of the first 3D video signal and right and left eye full-screen image frames of the second 3D video signal;
wherein the right shutter of the second pair of shutter glasses is turned on in sync with display of right eye full-screen image frames of the second 3D video signal, and turned off in sync with display of left eye full-screen image frames of the second 3D video signal and right and left eye full-screen image frames of the first 3D video signal; and
wherein the left shutter of the second pair of shutter glasses is turned on in sync with display of left eye full-screen image frames of the second 3D video signal, and turned off in sync with display of right eye full-screen image frames of the second 3D video signal and right and left eye full-screen image frames of the first 3D video signal.

7. The display system of claim 5, wherein order of alternation of the alternating right and left eye full-screen image frames of the first 3D video signal and the second 3D video signal is one set of right and left eye full-screen image frames of the first 3D video signal followed by one set of right and left eye full-screen image frames of the second 3D video signal.

8. The display system of claim 5, wherein order of alternation of the alternating right and left eye full-screen image frames of the first 3D video signal and the second 3D video signal is one right eye full-screen image frame of the first 3D video signal, followed by one right eye full-screen image frame of the second 3D video signal, followed by one left eye full-screen image frame of the first 3D video signal, followed by one left eye full-screen image frame of the second 3D video signal.

9. A display system for displaying multiple video signals in a single display, the display system comprising:
a first video source for outputting a first video signal;
a second video source for outputting a second video signal;
a display module for displaying an image frame;
a system control module coupled to the first video source and the second video source for receiving the first video signal and the second video signal, and generating an image signal comprising a first set of a plurality of pixels of the first video signal and a second set of the plurality of pixels of the second video signal; and
a polarizing module attached to the LCD module, the polarizing module comprising a plurality of first polarizing regions of a first polarization and a plurality of second polarizing regions of a second polarization opposite the first polarization;
wherein the first set of the plurality of pixels correspond to the plurality of first polarizing regions, and the second set of the plurality of pixels correspond to the plurality of second polarizing regions.

10. The display system of claim 9, further comprising:
a first pair of polarized glasses comprising right and left polarizing filters of a first polarization;
a second pair of polarized glasses comprising right and left polarizing filters of a second polarization opposite the first polarization.

11. The display system of claim 9, wherein each first polarizing region corresponds to one pixel of the LCD module, and each second polarizing region corresponds to one pixel of the LCD module.

12. The display system of claim 9, wherein the first set of the plurality of pixels and the second set of the plurality of pixels are patterned in alternating rows, and the plurality of first polarizing regions and the plurality of second polarizing regions are patterned in alternating polarizing rows corresponding to the alternating rows.

13. The display system of claim 9, wherein the first set of the plurality of pixels and the second set of the plurality of pixels are patterned in alternating columns, and the plurality of first polarizing regions and the plurality of second polarizing regions are patterned in alternating polarizing columns corresponding to the alternating columns.

14. The display system of claim 9, wherein the first set of the plurality of pixels and the second set of the plurality of pixels are patterned in a checkerboard arrangement, and the plurality of first polarizing regions and the plurality of second polarizing regions are patterned in a corresponding checkerboard arrangement.

15. A method of displaying multiple video signals in a single display, the method comprising:
receiving a first video signal;
receiving a second video signal;
generating an image signal comprising alternating full-screen image frames of the first video signal and the second video signal;
displaying the image signal in the display;
controlling left and right shutters of a first pair of shutter glasses to allow transmission of light in sync with the full-screen image frames of the first video signal, and to block transmission of light in sync with the full-screen image frames of the second video signal; and
controlling left and right shutters of a second pair of shutter glasses to allow transmission of light in sync with the full-screen image frames of the second video signal, and to block transmission of light in sync with the full-screen image frames of the first video signal.

16. The method of claim 15, wherein the left and right shutters of first pair of shutter glasses are controlled by a first synchronization signal transmitted by the display, and the second pair of shutter glasses are controlled by a second synchronization signal transmitted by the display.

17. The method of claim 15, wherein:
receiving the first video signal is receiving a first 3D video signal; and
receiving the second video signal is receiving a second 3D video signal.

18. The method of claim 17, wherein controlling the left and right shutters of the first pair of shutter glasses to allow transmission of light in sync with the full-screen image frames of the first video signal, and to block transmission of light in sync with the full-screen image frames of the second video signal; and controlling the left and right shutters of the second pair of shutter glasses to allow transmission of light in sync with the full-screen image frames of the second video signal, and to block transmission of light in sync with the full-screen image frames of the first video signal comprises:
controlling the right shutter of the first pair of shutter glasses to allow transmission of light in sync with right eye full-screen image frames of the first 3D video signal, and to block transmission of light in sync with left eye full-screen image frames of the first video signal and right and left eye full-screen image frames of the second 3D video signal;
controlling the left shutter of the first pair of shutter glasses to allow transmission of light in sync with left eye full-screen image frames of the first video signal, and to block transmission of light in sync with right eye full-screen image frames of the first video signal and right and left eye full-screen image frames of the second 3D video signal;
controlling the right shutter of the second pair of shutter glasses to allow transmission of light in sync with right eye full-screen image frames of the second 3D video signal, and to block transmission of light in sync with left eye full-screen image frames of the second video signal and right and left eye full-screen image frames of the first 3D video signal; and
controlling the left shutter of the second pair of shutter glasses to allow transmission of light in sync with left eye full-screen image frames of the second 3D video signal, and to block transmission of light in sync with right eye full-screen image frames of the second video signal and right and left eye full-screen image frames of the first 3D video signal.

19. The method of claim 18, wherein order of alternation of the alternating right and left eye full-screen image frames of the first 3D video signal and the second 3D video signal is one set of right and left eye full-screen image frames of the first 3D video signal followed by one set of right and left eye full-screen image frames of the second 3D video signal.

20. The method of claim 13, wherein order of alternation of the alternating right and left eye full-screen image frames of the first 3D video signal and the second 3D video signal is one right eye full-screen image frame of the first 3D video signal, followed by one right eye full-screen image frame of the second 3D video signal, followed by one left eye full-screen image frame of the first 3D video signal, followed by one left eye full-screen image frame of the second 3D video signal.

21. A method of displaying multiple video signals in a single display, the method comprising:
providing a first pair of polarized glasses of a first polarization;
providing a second pair of polarized glasses of a second polarization opposite the first polarization;
providing a polarizing module attached to a display module of the display, the polarizing module comprising a plurality of first polarizing regions of the first polarization and a plurality of second polarizing regions of the second polarization;
receiving a first video signal;
receiving a second video signal;
generating an image signal comprising a first set of a plurality of pixels of the first video signal and a second set of the plurality of pixels of the second video signal; and
displaying the image signal in the display;
wherein the first set of the plurality of pixels corresponds to the plurality of first polarizing regions, and the second set of the plurality of pixels corresponds to the plurality of second polarizing regions.

22. The method of claim 21, wherein generating the image signal comprising the first set of the plurality of pixels of the first video signal and the second set of the plurality of pixels of the second video signal is generating an image signal comprising the first set of the plurality of pixels and the second set of the plurality of pixels arranged in an alternating row pattern.

23. The method of claim 21, wherein generating the image signal comprising the first set of the plurality of pixels of the first video signal and the second set of the plurality of pixels of the second video signal is generating an image signal comprising the first set of the plurality of pixels and the second set of the plurality of pixels arranged in an alternating column pattern.

24. The method of claim 21, wherein generating the image signal comprising the first set of the plurality of pixels of the first video signal and the second set of the plurality of pixels of the second video signal is generating an image signal comprising the first set of the plurality of pixels and the second set of the plurality of pixels arranged in a checkerboard pattern.
